(19) United States
(12) Patent Application Publication
(10) Pub. No.: US 2025/0052900 A1
(43) Pub. Date: Feb. 13, 2025

(54) STATIONARY TRAFFIC MONITORING SYSTEM FOR MONITORING A DETECTION REGION OF A TRAFFIC AREA AND DESIGNED TO COMMUNICATE WITH VEHICLES TRAVELLING ON THE TRAFFIC AREA, AND MOTOR VEHICLE

(71) Applicant: Jenoptik Robot GmbH, Monheim (DE)

(72) Inventor: Günter FENDT, Schrobenhausen (DE)

(73) Assignee: Jenoptik Robot GmbH, Monheim (DE)

(21) Appl. No.: 18/718,584

(22) PCT Filed: Dec. 9, 2022
(86) PCT No.: PCT/EP2022/085206

§ 371 Date: Jun. 11, 2024

(30) Foreign Application Priority Data
Dec. 11, 2021 (DE) 10 2021 006 106.3

(51) Int. Cl. G01S 17/86; G01S 7/499; G08G 1/01

(52) U.S. Cl. CPC G01S 17/86; G01S 7/499; G08G 1/0116; G08G 1/0141

(57) ABSTRACT

A stationary traffic monitoring system and method for monitoring a detection region of a traffic area designed to communicate with vehicles travelling on the traffic area in which a system unit monitors a detection region of a traffic area and/or designed for communication. A motor vehicle, wherein two or more optical interfaces are used, is characterised in that a first data transmission interface is operated with a polarised transmitted light beam, and a laser scanner is operated with a polarised transmitted light beam, and/or a second data transmission interface is operated with a polarised transmitted light beam. The polarisation plane of the polarised transmitted light beam of the first data transmission interface is different from the polarisation plane of the polarised transmitted light beam of the laser scanner and/or of the polarised transmitted light beam of the second data transmission interface.

The present invention relates to a stationary traffic monitoring system for monitoring a detection region of a traffic area and designed to communicate with vehicles driving on the traffic area, a method for a system unit, designed as a stationary traffic monitoring system and/or as a motor vehicle, for monitoring a detection region of a traffic area and/or designed for communication, and a motor vehicle.

Stationary traffic monitoring systems, in particular in the sense of what are known as stationary infrastructure systems, are used for various applications, for example as what are known as traffic guidance systems in which the traffic routing (in particular speed specifications) is adaptively adjusted to the upcoming traffic situation and/or the prevailing weather conditions, or as what are known as speed monitoring systems (also known as “speed cameras” or “radar”). Newer generations of stationary traffic monitoring systems also have what are known as “calibration functions” for passing vehicles.

DE 10 2016 000 532 A1 proposes, for this purpose, a calibration of a device of a vehicle, for example a speedometer, using a traffic monitoring device.

A method for monitoring and/or detecting a sensor system of a vehicle is known from DE 10 2018 106 594 A1, said method comprising a step of determining a parameter value using a response signal, and a step of determining a monitoring signal that can be assigned to the sensor system using the parameter value and a predetermined response value.

DE 10 2014 008 732 B4 discloses a traffic monitoring system for monitoring a detection region of a traffic area, the monitoring system having the following features:
a) a radar system for detecting the detection region, the radar system being designed to provide a radar measurement value comprising information about a vehicle located in the detection region;
b) a laser scanner which is aligned with the detection region and is designed to provide a laser measurement value which comprises information about the vehicle located in the detection region; and
c) a device for checking the plausibility of the radar measurement value using the laser measurement value, the radar measurement value representing a measurement value of the radar system and the laser measurement value representing a measurement value of the laser scanner.

DE 10 2018 118 190 A1 discloses a method for monitoring the driving behavior of a highly automated driving vehicle, the method comprising a step of reading in an input signal that represents indication data on the driving behavior of the highly automated driving vehicle. The method also comprises a step of performing a comparison of the driving behavior with a predefined reference driving behavior in order to generate a comparison result. The method also comprises a step of providing an output signal depending on the comparison result. In this case, the output signal represents control information about the driving behavior in relation to the reference driving behavior.

The current traffic monitoring systems for monitoring a detection region of a traffic area are currently primarily designed to detect vehicles so that the vehicles can be monitored (e.g. compliance with rules/speeding) and an adaptive adjustment of the traffic flow (traffic control) can be made on the basis of the current traffic volume (e.g. in the form of traffic guidance systems).

A development of a stationary traffic monitoring system for monitoring a detection region of a traffic area, a method for a stationary traffic monitoring system, as well as the use of a stationary traffic monitoring system for monitoring a detection region of a traffic area, which has been specially developed for monitoring (a) lighting device(s) in passing vehicles, is known from the not pre-published prior art DE 10 2021 000 323.3,
a) with regard to the correct functioning of said passing vehicles, and/or
b) with regard to the emission of one or more undesired frequency/frequencies and/or an undesired frequency spectrum or a plurality of undesired frequency spectra.

DE 10 2018 210 399 A1 discloses a following vehicle comprising a communication device for receiving first and second vehicle-relevant data, the first vehicle-relevant data and the second vehicle-relevant data being redundant with respect to one another.

As is further disclosed in DE 10 2018 210 399 A1, two interfaces are used, in particular
a data transmission interface for receiving initial vehicle-relevant data via a first wireless transmission medium,
a data transmission interface for receiving second vehicle-relevant data via a second wireless transmission medium,
the first wireless transmission medium being designed differently from the second transmission medium.

In order to ensure the required data transmission quality and for a secure implementation of the safety-critical applications mentioned in part above, as is known from the prior art the data interfaces are often designed redundantly having different technologies, in order to achieve the greatest possible signal-to-noise ratio and to as far as possible avoid any possible mutual interference. A plausibility check or verification of the transmission content is also often carried out or certificates are used (e.g. DE 10 2020 211 473 A1) in order to be able to ensure appropriate security.

A popular solution (for reasons of simplicity) for avoiding any risk of mutual interference is to use different technologies (radio-based and optical interfaces) when using a plurality of data interfaces, or to use the plurality of interfaces with different parameters (different frequencies for radio-based interfaces, or different wavelengths for optical interfaces).

However, this type of circumvention of the potential danger is not always possible, for example if an optical interface is required in the overall system (in the system unit) for application-related reasons, and a laser scanner is used in parallel or simultaneously in the overall system, as the transmitted light beam of the laser scanner (e.g. due to the high pulse power) could cause “crosstalk” or overload of the receiver of the optical interface, or if two optical interfaces are required in the overall system (in the system unit) for application-related reasons.

### Problem Addressed by the Invention

The problem addressed by the invention can be considered that of proposing or providing a solution
a) for an improved stationary traffic monitoring system for monitoring a detection region of a traffic area, and/or
b) for a method for a system unit, designed as a stationary traffic monitoring system and/or as a motor vehicle, for monitoring a detection region of a traffic area and/or designed for communication.

### Solution to the Problem

The above problem is solved by the entire teaching of independent claim 1, as well as the teaching of coordinated claim 10. Advantageous developments are specified in the dependent claims, combinations not described in more detail or logical/obvious developments for a person skilled in the art also being included.

A significant advantage of the present invention over the prior art is that
a) in the case of stationary traffic monitoring systems for monitoring a detection region of a traffic area, and/or
b) in the case of system units, designed as a stationary traffic monitoring system and/or as a motor vehicle, for monitoring a detection region of a traffic area and/or designed for communication,
c) an increase in functional reliability can be achieved, even if two optical systems (laser scanner & optical interface, or optical interface & optical interface) are used simultaneously or in parallel in the overall system for application-related reasons.

In order to achieve this advantage, the present solution according to the invention therefore proposes that, depending on the application, it is ensured in the overall system (in the system unit) that, despite the simultaneous or parallel use of two or more optical systems, as far as possible no “crosstalk” or overloading of a receiver of an optical interface can occur, the objective pursued being achieved by using polarized transmitted light beams and ensuring by the design that
the polarization plane (E1) of the polarized transmitted light beam of the first optical system, in particular the first data transmission interface,
is different from the polarization plane (E2, E3) of the polarized transmitted light beam of the second (further) optical system, in particular the laser scanner, and/or the second data transmission interface.

If three optical systems are used simultaneously, the design must ensure that all three polarization planes (E1, E2, E3) are different from one another.

### Observation:

In the light of the invention, the expression “the polarized transmitted light beam of the first optical system,” or “the polarized transmitted light beam of the second (further) optical system,” is also to be understood as the associated polarized “received light beam” (which is reflected as a reflection on an object, or is sent back as a responding polarized transmitted light beam from the communication partner), or this is included in the corresponding polarization plane (E1, E2, E3) (is to be read in accordingly).

In other words:

An optical system in the form of a data interface is characterized in that both “communication partners” are oriented to a matching polarization plane in terms of transmission and reception, it being important to note that the angle of rotation of a polarization plane at the “communication partner” appears negated (must be taken into account) or must be taken into account in the opposite direction of rotation. In the case of a reflection, a typically slight change (rotation) of the polarization plane due to the reflection from an object must be taken into account in the received signal/receiver.

In order to prevent “crosstalk” from occurring in any of the individual receivers of the individual optical interfaces, or as far as possible to prevent overloading of a receiver of an optical interface, according to the invention a polarization filter is provided for each input of an optical interface, the polarization filter being adapted to the corresponding polarization plane to be received in each case.

DE 10 2013 219 344 A1 should be mentioned as a reference for explaining a polarization plane, in the content of which a method for determining a distance of an object by means of a polarization-modulated transmitted light beam is disclosed, wherein this publication DE 10 2013 219 344 A1 (together with the further prior art documents acknowledged at the beginning) does not anticipate the present solution according to the invention, since DE 10 2013 219 344 A1 neither addresses the problem of “crosstalk” or overloading of a receiver of an optical interface, let alone presents/discloses a solution for this, nor is a person skilled in the art given any indication of developing an overall system or system unit which contains more than one optical system which, if possible, do not interfere with each other and can be operated in parallel or simultaneously. The document DE 10 2013 219 344 A1, as well as the further prior art documents acknowledged at the beginning, can rather be regarded as a reference for the individual technical solutions, an overview of said documents not being obvious to a person skilled in the art, or not leading a person skilled in the art in an obvious way to the proposed solution according to the invention with its technical features.

### DESCRIPTION OF THE INVENTION

In order to propose or provide a further optimization in the field of stationary traffic monitoring systems for monitoring a detection region of a traffic area and designed to communicate with vehicles driving on the traffic area, a stationary traffic monitoring system is proposed, the monitoring system having at least the following features:
a) a first data transmission interface for receiving and/or transmitting first vehicle-relevant and/or traffic management-relevant data via a first wireless transmission medium, the first wireless transmission medium being designed as an optical interface, and
b) a laser scanner which is aligned with the detection region and is designed to provide a laser measurement value which comprises information about a vehicle located in the detection region, and/or
c) a second data transmission interface for receiving and/or transmitting second vehicle-relevant and/or traffic management-relevant data via a second wireless transmission medium, the second wireless transmission medium being designed as an optical interface, and being characterized in that
d) the first data transmission interface is operated with a polarized transmitted light beam, and
e) the laser scanner is operated with a polarized transmitted light beam, and/or
f) the second data transmission interface is operated with a polarized transmitted light beam,
g) wherein
the polarization plane (E1) of the polarized transmitted light beam of the first data transmission interface,
is different from the polarization plane (E2, E3) of the polarized transmitted light beam of the laser scanner and/or the polarized transmitted light beam of the second data transmission interface.

The phrase “has/having at least the following features” is to be understood in the light of the invention in such a way that it is not detrimental to the proposed solution if the monitoring system has further features, or further functional features are realized/implemented by means of the proposed monitoring device, or solutions are also to be understood in which existing monitoring systems are supplemented with features or functions in order to realize the object according to the invention by realizing/performing/implementing the characterizing features of claim 1, and/or the claims dependent thereon, in accordance with the proposed solution according to the invention.

In an advantageous embodiment of the invention, the stationary traffic monitoring system is characterized in that
a) the first data transmission interface for receiving and/or transmitting first vehicle-relevant and/or traffic management-relevant data, and
b) the second data transmission interface for receiving and/or transmitting second vehicle-relevant and/or traffic management-relevant data,
c) can be operated redundantly with respect to one another.

In addition to the possibility of mutual security (verification) of the transmitted information, the advantage of simultaneous redundant operation of a first data transmission interface and a second data transmission interface is also the fact that a larger data transmission bandwidth can be achieved with the simultaneous operation of two data transmission interfaces.

In a further advantageous embodiment of the invention, the stationary traffic monitoring system is characterized in that vehicle-relevant and/or traffic management-relevant information data can be transmitted on (by means of) (by means of) both data transmission interfaces.

In a further advantageous embodiment of the invention, the stationary traffic monitoring system is characterized in that vehicle-relevant and/or traffic management-relevant information data can be transmitted on (by means of) (by means of) one of the two data transmission interfaces, and communication-relevant control data and/or communication-relevant monitoring data can be transmitted on (by means of) the other of the two data transmission interfaces.

In a further advantageous embodiment of the invention, the stationary traffic monitoring system is characterized in that one of the two data transmission interfaces can be used as a unidirectional transmission interface, and the other of the two data transmission interfaces can be used as a unidirectional reception interface (are antiparallel acting).

In a further advantageous embodiment of the invention, the stationary traffic monitoring system is characterized in that both data transmission interfaces can be used simultaneously and do not have to have different modulation patterns for the purpose of differentiation. Instead, the differentiation occurs via the different polarization planes to which the individual receivers of the different optical interfaces are tuned or set.

In a further advantageous embodiment of the invention, the stationary traffic monitoring system is characterized in that the individual receivers of the different optical interfaces and/or optical systems are tuned and/or set to different polarization planes (E1, E2, E3), a polarization filter preferably being located at the input (connected upstream) of each receiver for this purpose, it being possible in this case both for the individual polarization filters to be implemented both as fixed polarization filters and/or also as individual polarization analyzers, which are each set to a predefined range by default, and during reception operation align themselves precisely with the polarization plane of the incoming polarized received light signal of the corresponding communication channel and/or optical interface and/or optical system by means of analysis. The alignment of the polarization filter(s) to a specific polarization plane of an incoming polarized received light signal of a specific signal originating from an optical interface has the effect that this incoming polarized received light signal can be received optimally (unhindered), whereas the further incoming polarized received light signals having a deviating polarization plane originating from further optical interfaces are received attenuated, or at best are completely masked out. The alignment of the polarization filter(s) to a specific polarization plane of an incoming polarized received light signal of a specific signal originating from an optical interface is preferably carried out automatically by adaptively adjusting the angle setting of the polarization filter to the incoming polarized received light signal until a maximum received signal strength is achieved. Using this method of automated adaptive adjustment of the polarization filter to a polarization plane of an incoming polarized received light signal, the advantage can be achieved that two “communication partners” (e.g. two vehicles having data transmission interfaces) can establish a communication link even if the corresponding polarization planes of the polarized transmitted light beams did not originally match. While communication is being established between the two “communication partners” (e.g. two vehicles having data transmission interfaces), it is thus possible to determine, even at the beginning of the communication, based on the number of optical systems involved, whether the polarization planes of the individual optical interfaces have a relative angle of (approx.) 90 degrees or approx. 120 degrees to one another, so that the “vehicle pairing” can be performed flexibly and there are no restrictions due to fixed specifications in the “vehicle pairing” (the system/the optical interfaces are preferably self-adapting with regard to the optimum alignment of the filter polarization plane(s)).

An optical system, or the term “optical system” is to be regarded as an umbrella term which, in the light of the invention, describes (includes) both an optical data transmission interface and a laser scanner.

In a further advantageous embodiment of the invention, in particular when the overall system has two optical systems, the stationary traffic monitoring system is characterized in that the difference
between the polarization plane (E1) of the polarized transmitted light beam of the first data transmission interface,
and the polarization plane (E2, E3) of the polarized transmitted light beam of the laser scanner, and/or the polarized transmitted light beam of the second data transmission interface,
relative to one another is a relative angle of approx. 90 degrees.

In a further advantageous embodiment of the invention, in particular when the overall system has three optical systems, the stationary traffic monitoring system is characterized in that the difference
between the polarization plane (E1) of the polarized transmitted light beam of the first data transmission interface,
and the polarization plane (E2) of the polarized transmitted light beam of the laser scanner, and
the polarization plane (E3) of the polarized transmitted light beam of the second data transmission interface,
relative to one another is a relative angle of approx. 120 degrees in each case.

Furthermore, the invention comprises a vehicle, or vehicles, which are designed to communicate with a stationary traffic monitoring system according to the above-mentioned features.

Furthermore, the invention comprises a method for a system unit, designed as a stationary traffic monitoring system and/or as a motor vehicle (motor vehicle, truck), for monitoring a detection region of a traffic area and/or designed for communication, the system unit having at least the following features:
a) a first data transmission interface for receiving and/or transmitting first vehicle-relevant and/or traffic management-relevant data via a first wireless transmission medium, the first wireless transmission medium being designed as an optical interface, and
b) a laser scanner which is aligned with the detection region and is designed to provide a laser measurement value which comprises information about a vehicle located in the detection region, and/or
c) a second data transmission interface for receiving and/or transmitting second vehicle-relevant and/or traffic management-relevant data via a second wireless transmission medium, the second wireless transmission medium being designed as an optical interface, and being characterized in that
d) the first data transmission interface is operated with a polarized transmitted light beam, and
e) the laser scanner is operated with a polarized transmitted light beam, and/or
f) the second data transmission interface is operated with a polarized transmitted light beam,
g) wherein
   the polarization plane (E1) of the polarized transmitted light beam of the first data transmission interface,
   is different from the polarization plane (E2, E3) of the polarized transmitted light beam of the laser scanner and/or the polarized transmitted light beam of the second data transmission interface.

In the example of the solution according to the invention, the laser scanner is used in particular to determine a distance, proceeding from the position of the laser scanner and an object in the detection region of the laser scanner, for example by using known time-of-flight measurement methods. The information about a vehicle located in the detection region is, in particular, distance information.

For example, the first vehicle-relevant and/or traffic management-relevant data and the second vehicle-relevant and/or traffic management-relevant data may be different as well as matching data, or the data may have an identical reference to each other, in particular if the data are information relating to the authenticity of the vehicle participating in the communication, for example in such a way that a communication between the infrastructure system or the stationary traffic monitoring system and a specific vehicle has been started via a first data transmission interface and is subsequently quasi verified, for comparison, via a second data transmission interface, in that a response or acknowledgment is sent via the second data transmission interface during/as a result of the communication via the first data transmission interface. As the example shows, the “redundant” first vehicle-relevant and/or traffic management-relevant data and the second vehicle-relevant and/or traffic management-relevant data may also be matching data, or the data may have an identical reference to one another, data that deviate from one another also being possible, in particular if communication takes place via “redundant” interfaces, such as what is known as a two-way process, in that communication takes place in a first direction using the first wireless transmission medium and communication takes place in a direction opposite to the first direction using the second wireless transmission medium (the redundancy can relate to the data or information itself, as well as to the interfaces involved, two interfaces always being required, and the vehicle-relevant data being e.g./in particular information for authenticity and/or for calibration and/or monitoring functions, and/or the traffic management-relevant data being in particular information relating to longitudinal and/or lateral guidance of the vehicle, or acknowledgment).

Instead of a second optical data transmission interface having a polarized transmitted light beam, the second optical system in the overall system can alternatively or additionally also be designed as a laser scanner having a polarized transmitted light beam.

The term “polarized transmitted light beam” can be considered, in the invention description/the application documents, as a synonym (generalized/abbreviated term) for “polarization-modulated transmitted light beam,” or as a “pulsed and/or modulated polarized transmitted light beam.”

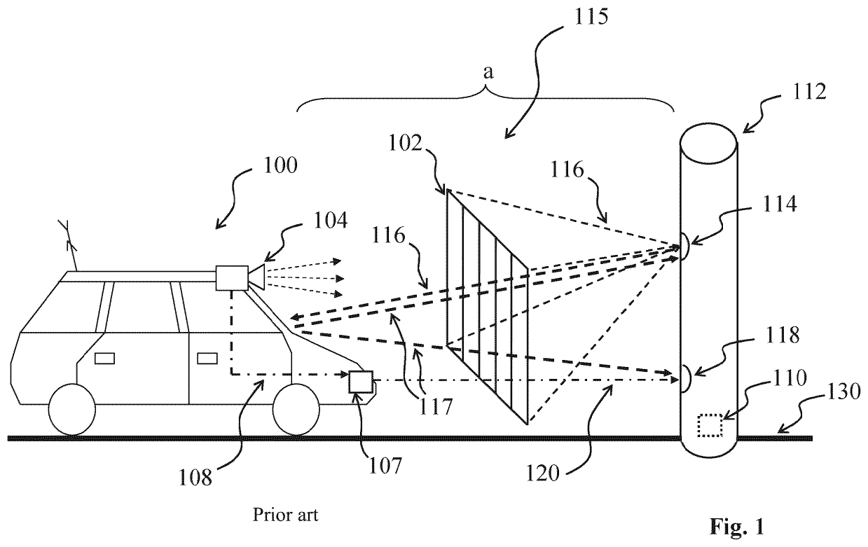

The invention is explained in more detail below, by way of example, with reference to FIG. 1 to 4. The figures and the values stated therein/to be derived therefrom (if available) are merely by way of example and serve to facilitate understanding.

All figures are schematic views (not to scale).

In the figures, schematically:

FIG. 1: is a schematic view of an excitation event for monitoring a sensor system of a vehicle by means of a stationary traffic monitoring system or stationary infrastructure system, based on the prior art according to DE 10 2018 106 594 A1;

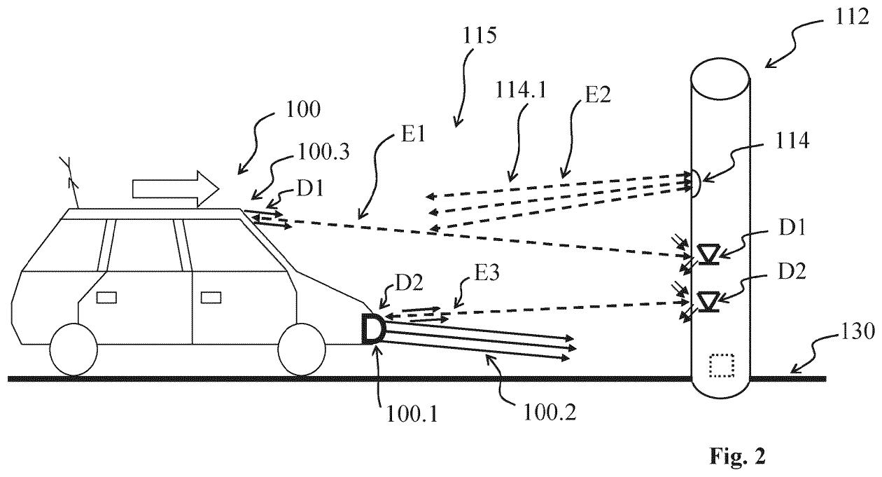

FIG. 2: is a schematic view of the solution according to the invention, the system unit representing a stationary traffic monitoring system, the representation showing, in a simplified manner, in particular the optical systems, in the form of two data transmission interfaces, as well as a laser scanner;

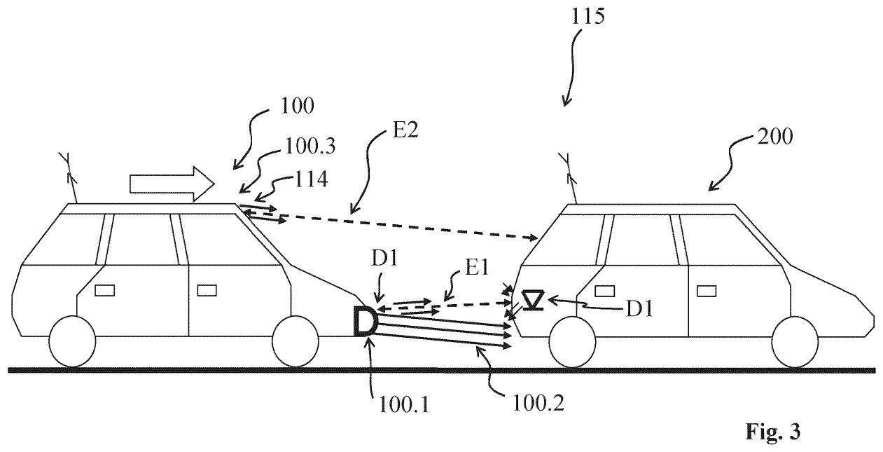

FIG. 3: is a schematic view of the solution according to the invention, the system unit representing a motor vehicle, the representation showing, in a simplified manner, in particular the optical systems, in the form of a data transmission interface, as well as a laser scanner;

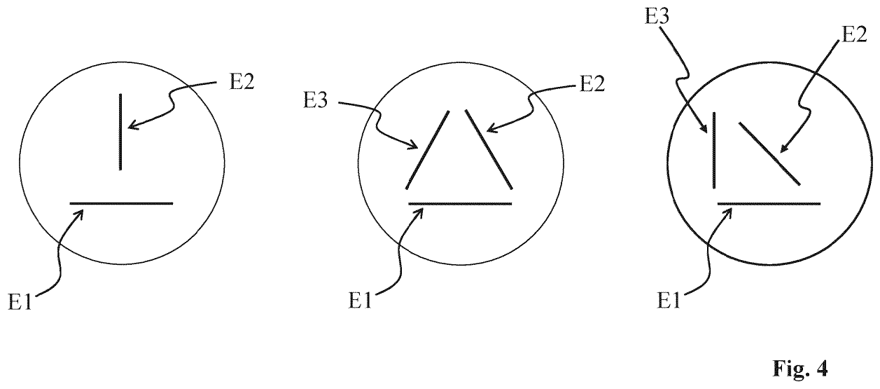

FIG. 4: is a schematic view of the alignment of the individual polarization planes, in the case of different numbers of optical systems in the overall system.

In order to avoid repetition, in particular repetition of technical factual descriptions, reference is made to the above-mentioned documents and the methods and devices/solutions disclosed therein, the content of which forms an integral part of the present invention.

FIG. 1 is a schematic view of an excitation event for monitoring a sensor system (104) of a vehicle (100) by means of a stationary traffic monitoring system (112) or stationary infrastructure system (112), based on the prior art according to DE 10 2018 106 594 A1. As can be seen in this respect from FIG. 1, an infrastructure system (112) is located at the edge of a roadway (130), which is driven on by a vehicle (100). The vehicle (100) is equipped with a sensor system (104), designed as an optical environment detection system (in particular a camera), in order to monitor the traffic area in the direction of travel. Furthermore, the vehicle (100) is provided with a communication interface (107) in order to be able to send or transmit a response signal (120) or communication signal (120) to the receiving device (118) of the infrastructure system (112). As can also be seen in FIG. 1, the communication interface (107) is connected to the sensor system (104) within the vehicle via an interface (108) within the vehicle or vehicle bus connection (108). As can also be seen from FIG. 1, the infrastructure system (112) has a transmitting device (114) for generating/transmitting, in the direction of the detection region (115), signals (116), for example in the form of an “invisible” laser curtain as an excitation event (102), or as a communication signal, or as a signal for a communication/communication interface. The infrastructure system (112) can also be generally referred to as a device (110), for reasons of clarity, the “inner workings” (e.g. internal interfaces) of the infrastructure system (112) not being shown in more detail. Likewise, the calibration process or the exact procedure for monitoring and/or detecting a sensor system (104) of a vehicle (100) with the aid of an infrastructure system (112) is not described in more detail, as this is already disclosed in detail in DE 10 2018 106 594 A1.

As can also be seen from FIG. 1, the transmitting device (114) located in the infrastructure system (112) can also be designed bidirectionally as a transmitting/receiving device in order to receive the transmitted signal (116) (e.g. laser pulse(s)) and the received signal (117) scattered back from the vehicle (100), and to make it available internally for further processing. Alternatively, the transmitted signal (116) and the received signal (117) scattered back from the vehicle (100) can also be received by the receiving device (118) in order to make it available internally for further processing.

FIG. 2 is a schematic view of the solution according to the invention, the system unit representing a stationary traffic monitoring system (112), the representation showing, in a simplified manner, in particular the optical systems, in the form of two data transmission interfaces (D1, D2), as well as a laser scanner (114).

Analogously to FIG. 1, FIG. 2 shows a vehicle (100) which is driving on a roadway (130), the vehicle (100) moving towards the stationary traffic monitoring system (112) or the stationary infrastructure installation (112) during the journey, and/or the vehicle (100) passing the stationary traffic monitoring system (112) or the stationary infrastructure system (112) during the course of the onward journey, the term “passing” being intended to be considered generally, in that an approaching movement (the area of the approaching movement) of the vehicle (100) within the detection region of the stationary traffic monitoring system (112) or the stationary infrastructure system (112) is included in the term “passing.”

As can also be seen from FIG. 2, the stationary traffic monitoring system (112) has a laser scanner (114), a first data transmission interface (D1) and a second data transmission interface (D2), the detection direction or detection characteristic of the two data transmission interfaces (D1, D2), like the detection direction (114.1) or detection characteristic (114.1) of the laser scanner (114), being directed towards a monitoring region (115) of a roadway portion of the roadway (130), the monitoring region (115) of the two data transmission interfaces (D1, D2) and of the laser scanner (114) not necessarily having to coincide, since the range of the different optical systems (D1, D2, 114) already results in different extensions of the monitoring region (115) to be monitored. The individual polarized transmitted light beams of the individual optical systems (D1, D2, 114) have different polarization planes (E1, E2, E3) that deviate from one another.

As can also be seen from FIG. 2, corresponding optical interfaces are located in the vehicle (100), in the form of a first data transmission interface (D1) and a second data transmission interface (D2), which are directed forwards in the direction of travel of the vehicle (100), the first data transmission interface (D1) being located in the region of what is known as the roof node (100.3) of the vehicle (100), and the second data transmission interface (D2) being located in the region of the front headlights (100.1) of the vehicle (100). For this purpose, the second data transmission interface (D2) can be designed as a separate unit in the region of the front headlights (100.1) of the vehicle (100), or can also be realized by the lighting device (100.1), at least in terms of transmission technology, by means of modulation or superimposition (in the case) of the light emission (100.2).

As can also be seen from FIG. 2, the first data transmission interface (D1) and the second data transmission interface (D2) are realized as bidirectional interfaces (having a transmitting and receiving device) both in the stationary traffic monitoring system (112) and in the vehicle (100).

FIG. 3 is a schematic view of the solution according to the invention, the system unit representing a motor vehicle (100), the representation showing, in a simplified manner, in particular the optical systems, in the form of a data transmission interface (D1), as well as a laser scanner (114).

As can be seen from FIG. 2, a vehicle (100) is shown which is driving on a roadway (130), the vehicle (100) following another vehicle (200) driving in front.

As can also be seen from FIG. 3, the vehicle (100) has a laser scanner (114) and a first data transmission interface (D1), the detection direction or detection characteristic of the data transmission interface (D1), like the detection direction or detection characteristic of the laser scanner (114), being directed towards a monitoring region (115) of a roadway portion of the roadway (130), the monitoring region (115) of the data transmission interface (D1) and of the laser scanner (114) not necessarily having to coincide, since the range of the different optical systems (D1, 114) already results in different extensions of the monitoring region (115) to be monitored. The individual polarized transmitted light beams of the individual optical systems (D1, 114) have different polarization planes (E1, E2) that deviate from one another.

As can also be seen from FIG. 3, the laser scanner (114) is located in the vehicle (100), in the region of what is known as the roof node (100.3) of the vehicle (100), and the first data transmission interface (D1) is located in the region of the front headlights (100.1) of the vehicle (100). For this purpose, the first data transmission interface (D1) can be designed as a separate unit in the region of the front headlights (100.1) of the vehicle (100), or can also be realized by the lighting device (100.1), at least in terms of transmission technology, by means of modulation or superimposition (in the case) of the light emission (100.2).

As can also be seen from FIG. 3, there is a corresponding optical interface (D1) in the vehicle (200), in the form of a first data transmission interface (D1), which is directed to the rear in the opposite direction to the direction of travel of the vehicle (100), the first data transmission interface (D1) being located in the region of the taillights of the vehicle (200). For this purpose, the first data transmission interface (D1) can be designed as a separate unit in the region of the rear taillights of the vehicle (200), or can also be realized by the lighting device, at least in terms of transmission technology, by means of modulation or superimposition (in the case) of the light emission.

As can also be seen in FIG. 3, the first data transmission interface (D1) is realized as bidirectional interfaces (having a transmitting and receiving device) both in the vehicle (100) and in the other vehicle (200) driving in front.

In the case of the laser scanner of FIG. 2 and FIG. 3, the polarized transmitted light beam of the laser scanner (114) reflected at the vehicle (100) or at the vehicle (200) forms the corresponding received signal of the optical interface.

In this example, the detection region (115) to which the laser scanner (114) is aligned is the region located in front of the vehicle (100) in the direction of travel, or the travel trajectory region located in front of the vehicle (100) in the direction of travel.

FIG. 4 is a schematic view of the alignment of the individual polarization planes (E1, E2, E3) in the solution according to the invention, with a different number of optical systems in the overall system (in the system unit). The left-hand view of FIG. 4 shows the preferred alignment of the relative position of the polarization planes (E1, E2), which are preferably located at a relative angle of (approx.) 90 degrees to one another, this implementation always being preferable if the overall system (in the system unit) has two optical systems. The middle view of FIG. 4 shows the preferred alignment of the relative position of the polarization planes (E1, E2, E3), which are preferably at a relative angle of (approx.) 120 degrees to one another, this realization always being preferable if the overall system (in the system unit) has three optical systems. As the right-hand view of FIG. 4 shows, further variations with regard to the relative position of the polarization planes (E1, E2, E3) are also realizable/possible.

1. A stationary traffic monitoring system for monitoring a detection region of a traffic area and designed to communicate with vehicles driving on the traffic area, the monitoring system comprising:
a first data transmission interface for receiving and/or transmitting first vehicle-relevant and/or traffic management-relevant data via a first wireless transmission medium, the first wireless transmission medium being designed as an optical interface, and
a laser scanner which is aligned with the detection region and is designed to provide a laser measurement value which comprises information about a vehicle located in the detection region, and/or
a second data transmission interface for receiving and/or transmitting second vehicle-relevant and/or traffic management-relevant data via a second wireless transmission medium, the second wireless transmission medium being designed as an optical interface, wherein
the first data transmission interface is operated with a polarized transmitted light beam, and
wherein the laser scanner is operated with a polarized transmitted light beam, and/or
wherein the second data transmission interface is operated with a polarized transmitted light beam, and
wherein
the polarization plane of the polarized transmitted light beam of the first data transmission interface, is different from the polarization plane (of the polarized transmitted light beam of the laser scanner and/or the polarized transmitted light beam of the second data transmission interface.

2. The stationary traffic monitoring system according to claim 1, wherein
a) the first data transmission interface for receiving and/or transmitting first vehicle-relevant and/or traffic management-relevant data, and
b) the second data transmission interface for receiving and/or transmitting second vehicle-relevant and/or traffic management-relevant data,
c) can be operated redundantly with respect to one another.

3. The stationary traffic monitoring system according to claim 1, wherein vehicle-relevant and/or traffic management-relevant information data can be transmitted on (by means of) the two data transmission interfaces, and/or in that vehicle-relevant and/or traffic management-relevant information data can be transmitted on (by means of) one of the two data transmission interfaces, and communication-relevant monitoring data and/or communication-relevant control data can be transmitted on (by means of) the other of the two data transmission interfaces.

4. The stationary traffic monitoring system according to claim 1, wherein one of the two data transmission interfaces can be used as a unidirectional transmission interface, and the other of the two data transmission interfaces can be used as a unidirectional reception interface.

5. The stationary traffic monitoring system according to claim 1, wherein both data transmission interfaces can be used simultaneously and do not have to have different modulation patterns for the purpose of differentiation.

6. The stationary traffic monitoring system according to claim 1, wherein the individual receivers of the different optical interfaces and/or optical systems are tuned and/or set to different polarization planes, a polarization filter preferably being located at the input of each receiver for this purpose, it being possible in this case for the individual polarization filters to be implemented both as fixed polarization filters and/or also as individual polarization analyzers, which are each set to a predefined range by default, and during reception operation align themselves precisely with the polarization plane of the incoming polarized received light signal of the corresponding communication channel and/or optical interface by means of analysis.

7. The stationary traffic monitoring system according to claim 1, wherein the difference
between the polarization plane of the polarized transmitted light beam of the first data transmission interface,
and the polarization plane of the polarized transmitted light beam of the laser scanner, and/or the polarized transmitted light beam of the second data transmission interface
relative to one another is a relative angle of approx. 90 degrees.

8. The stationary traffic monitoring system according to claim 1, wherein the difference
between the polarization plane of the polarized transmitted light beam of the first data transmission interface,
and the polarization plane of the polarized transmitted light beam of the laser scanner, and
the polarization plane of the polarized transmitted light beam of the second data transmission interface,
relative to one another is a relative angle of approx. 120 degrees in each case.

9. The vehicle designed to communicate with a stationary traffic monitoring system according to claim 1.

10. The method for a system unit, designed as a stationary traffic monitoring system and/or as a motor vehicle, for monitoring a detection region of a traffic area and/or designed for communication, the system unit having at least the following features:
a) a first data transmission interface for receiving and/or transmitting first vehicle-relevant and/or traffic management-relevant data via a first wireless transmission medium, the first wireless transmission medium being designed as an optical interface, and
b) a laser scanner which is aligned with the detection region and is designed to provide a laser measurement value which comprises information about a vehicle located in the detection region, and/or
c) a second data transmission interface for receiving and/or transmitting second vehicle-relevant and/or traffic management-relevant data via a second wireless transmission medium, the second wireless transmission medium being designed as an optical interface, wherein
d) the first data transmission interface is operated with a polarized transmitted light beam, and
e) the laser scanner is operated with a polarized transmitted light beam, and/or
f) the second data transmission interface is operated with a polarized transmitted light beam,
g) wherein
the polarization plane of the polarized transmitted light beam of the first data transmission interface,
is different from the polarization plane of the polarized transmitted light beam of the laser scanner and/or the polarized transmitted light beam of the second data transmission interface.
